(19) United States
(12) Patent Application Publication
(10) Pub. No.: US 2013/0151322 A1
(43) Pub. Date: Jun. 13, 2013

(54) Incentive Manager During Online Checkout

(71) Applicants: Gregory Anthony Coviello, Bellevue, WA (US); Sebastian Kohlmeier, Seattle, WA (US)

(72) Inventors: Gregory Anthony Coviello, Bellevue, WA (US); Sebastian Kohlmeier, Seattle, WA (US)

(73) Assignee: MICROSOFT CORPORATION, Redmond, WA (US)

(21) Appl. No.: 13/314,868

(22) Filed: Dec. 8, 2011

(51) Int. Cl. G06Q 30/02

(52) U.S. Cl. 705/14.23

(57) ABSTRACT

Described is a technology by which an incentive manager uses a portion of an interactive window associated with online commerce to provide incentives related to user of payment instruments. Upon detecting interaction with a set of displayed incentives corresponding to user-indicated payment options, an information input mechanism for collecting information related to the user-indicated option is expanded on the interactive window. Detection of interaction with an interactive mechanism may be used to expand the displayed incentive set.

### BACKGROUND

Online commerce is an ever growing and competitive technology that in many ways benefits customers (also referred to as users herein), producers and the entities that handle the financial part of the transactions. U.S. patent application Ser. No. 13/161,642, assigned to the assignee of the present application and herein incorporated by reference in its entirety, is generally directed towards a “smart routing” technology that computes the costs and cost savings of various payment instruments, such as to determine the cost of a potential transaction based upon the types of payment instruments that a customer is able to use. For example, the smart routing technology computes the cost of each of the available payment instruments for a potential sale to a customer based upon an analysis of transaction costs for the payment methods available to that customer/in that customer's country.

While this information is useful, there needs to be a way to incentivize a user who typically uses (or is planning to use) a more expensive payment instrument to switch to one that is less costly to the merchant. The incentive has to be sufficiently valuable such that enough users are enticed (on a statistical basis) to switch, yet has to be at a cost level that allows the merchant to recoup the cost of any offered incentive (also on a statistical basis) over time.

At the same time, the incentive has to be presented in such a way that the entire sale is not lost. More particularly, one of the problems in online commerce results from switching users from the checkout window (also referred to as a screen or a page) to another site or window. Some users who are familiar and comfortable with a merchant's site and checkout window become wary when they leave the existing payment process and/or are redirected to another site or window that collects their personal and financial data to complete the transaction. This results in the user deciding not to make the purchase. In other situations, before committing to a purchase, a potential customer looks around other websites for deals and discounts, and never gets back to completing the purchase.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an interactive window associated with online commerce provides a displayed incentive set comprising one or more displayed options related to use of a corresponding one or more payment instruments. Upon detecting interaction with the displayed incentive set that is directed towards selection of a user-indicated option, an information input mechanism for collecting information related to the user-indicated option is expanded on the interactive window. Detection of interaction with an interactive mechanism may be used to expand the displayed incentive set.

In one aspect, an incentive manager provides incentives related to payment instruments for online commerce based upon computed incentive data. The incentives are presented to a user on a visible window as an incentive set comprising one or more payment options and any associated incentives. If interaction with a payment option is detected and additional information is needed in order to use that payment option, the incentive manager expands an input area on the visible window to provide one or more data entry fields to collect the additional information.

In one aspect, a checkout window for online commerce is provided, including visible representations of payment instruments for selection. An interactive mechanism directed towards offering incentives is provided, and upon detection with the interactive mechanism, an area of the checkout window is expanded to provide an interactive incentive set comprising one or more payment options and any associated incentives. Upon detecting interaction with a payment option of the interactive incentive set, if additional information is needed in order to use that payment option, an area of the checkout window is expanded to provide a data entry area to collect the additional information.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components configured for providing incentives to online commerce users according to one example embodiment.

FIGS. 2-4 comprise representations of an online commerce checkout window that expands to facilitate additional user input based upon user interaction directed towards choosing an incentive according to one example embodiment.

FIGS. 5 and 6 comprise representations of an alternative online commerce checkout window that expands to facilitate additional user input based upon user interaction directed towards choosing an incentive according to one example embodiment.

FIGS. 7 and 8 comprise a flow diagram representing example steps that may be taken to provide an expanding checkout window according to one example embodiment.

FIG. 9 is a block diagram representing an example computing environment into which aspects of the subject matter described herein may be incorporated.

### DETAILED DESCRIPTION

Various aspects of the technology described herein are generally directed towards incentivizing a customer to switch to a payment instrument that is less costly to the merchant, while operating to facilitate completion of the purchase. To these ends, an incentive (e.g., a discount and/or a reward) is computed and offered for a customer to switch to a less costly payment instrument. The offering of the incentive or incentives, and the collection of the information needed to perform the switch occurs on a single window that is part of the checkout process. This is accomplished by showing the set of one or more incentives and expanding the related options offered to the user on that same window, whereby sales are typically not lost because of the user hunting for discounts elsewhere, and/or because of changing windows during the switching process.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in online commerce in general.

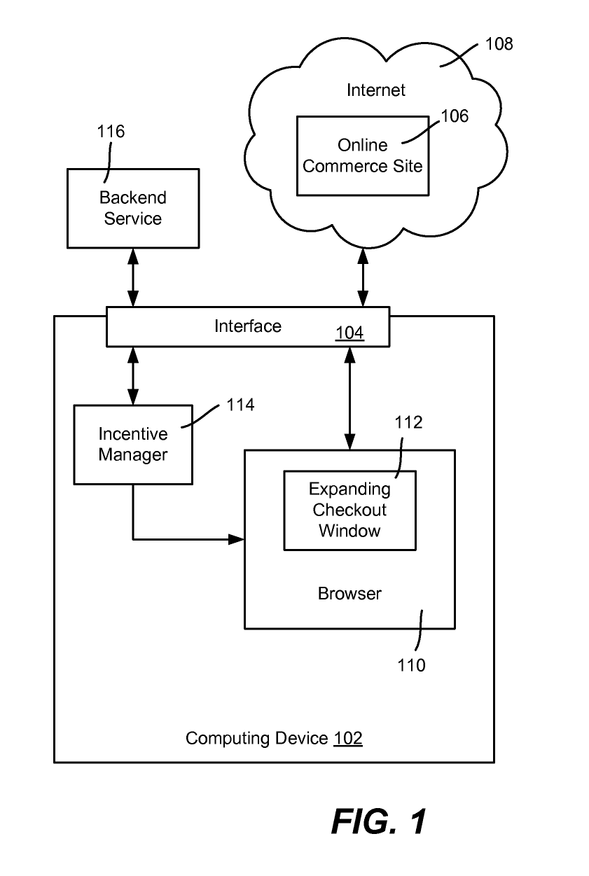

FIG. 1 shows a block diagram in which a computing device 102 is connected via a suitable wired or wireless interface 104 to an online commerce site 106 on the internet 108. As is known, browser code 110 renders various user interface windows (including frames) as a user navigates through the online commerce site 106, designating one or more items for potential purchase. To complete the purchase, the user navigates to a checkout window.

As described herein, an expanding checkout window 112 is provided in which the user completes the purchase. As will be understood, the expanding checkout window provides a representation of any previously persisted user data to facilitate the checkout. In conjunction with the presentation of the window, an incentive manager 114 (such as a browser add-on, or code within the page data being processed by the browser code 110) communicates with a backend service 116 (one or more servers or the like that provides the technology described in the aforementioned patent application) to determine whether to present an incentive to the user to change payment instruments, and if so, what incentive or incentives to provide.

In general, the incentive manager comprises the software code/logic corresponding to the expanding checkout window/screen, by which the customer can complete various activities (e.g. accepting or denying the incentive options, providing additional data input, and so forth) in an intuitive way. The incentive manager may be considered as including the page/portion of the page that obtains subsequent user input that is needed to enact the savings as determined by the backend service's smart routing logic; subsequent payment processing flows are triggered from and contained on this page/portion of the page from the user's perspective.

With respect to determining what incentive or incentives to provide, in addition to determining the cost of each payment instrument, a predicted value may be associated with each customer, essentially via a risk/reward computation that may be computed based upon the customer's relationship (historical transaction record) with the merchant (or possibly a group of merchants). For example, an established customer who is responsible with respect to paying is ordinarily associated with a higher value than is a newer customer. In general, the greater the customer's predicted value, the larger the incentive that may be offered to that customer, based upon the likelihood of recouping the incentive cost. Thus, a customer may get a discount or reward for changing the payment instrument, with possibly an additional discount for switching based on that individual customer's lifetime value and/or predicted value.

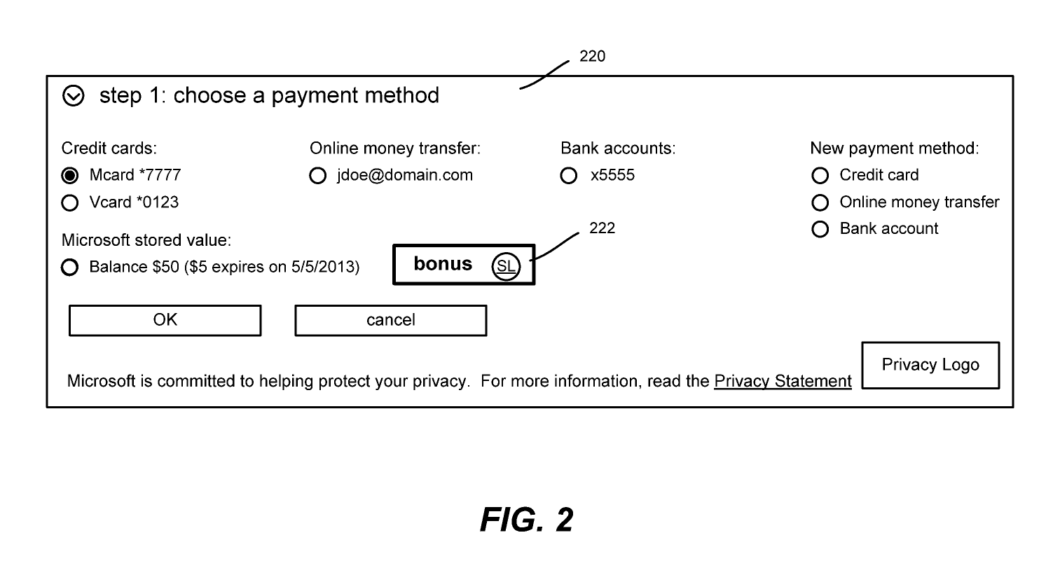

If an incentive to change the payment instrument is deemed worthwhile to present to the user, a mechanism to present the incentive to the user is provided. If the user is interested in possibly accepting the incentive, an appropriate data entry area expands on the checkout window so that any additional information needed from the user is collected without changing windows. By way of example, FIGS. 2-4 show a representation of an expanding checkout window. It should be understood that the representation's layout and any of the text, graphics, elements, components, interactive mechanisms (e.g., buttons) and so forth are only non-limiting examples for purposes of illustration.

In the example of FIGS. 2-4, a user who has previously been a customer has elected to purchase some items from a merchant and has placed one or more items in the user's cart, totaling $42.00. The user proceeds to checkout; in this simplified example, shipping is not considered, which may be because the one or more items comprise digital content.

When the user elects to proceed to checkout, the backend service is invoked by the incentive manager 112, whereby various cost saving options are calculated for the user and returned, along with the user's prior payment data to expedite the checkout process.

As can be seen in FIG. 2, the checkout screen includes an expanding screen portion 220 that is implemented via the incentive manager 114, and appears with the user's default payment instrument selected (a particular credit card in this example). In this example, the incentive manager 114 in conjunction with the backend service 116 have determined that an incentive is worthwhile to offer to thus user, and thus a “bonus” button 222 is provided proximate (e.g., adjacent) the computed lowest cost option; note that the location of the bonus button may be dynamic or static. In this example, the computed lowest cost option corresponds to a cash balance that the user has with the merchant, referred to as a Currency Stored Value (CSV). The bonus button 222 may be made to stand out in some way, e.g., by its size, color, by flashing, via animations, and so forth. Note that the bonus button may not always appear, such as when there is no savings that justifies an incentive, e.g., if the user already has the lowest-cost payment instrument selected by default.

The bonus button 222 also may display details of the incentives that are available, such as the maximum discount potential, reward potential, and/or external sponsorship branding such as a sponsor's logo (SL), e.g., because part of the bonus is being funded by a sponsor (e.g., like an advertiser), or the sponsor has otherwise paid to have a link associated with the bonus. For example, consider that the backend service 116 has provided information that this particular customer has demonstrated purchasing characteristics that are representative of a profile of the type of buyers that a luxury car manufacturer wants to target. Such a manufacturer may decide to pay to display a maximum reward available (not shown in FIG. 2) to entice the customer to click the bonus button 222; what is displayed may depend on the profile of the customer that is reviewed at the backend service 116.

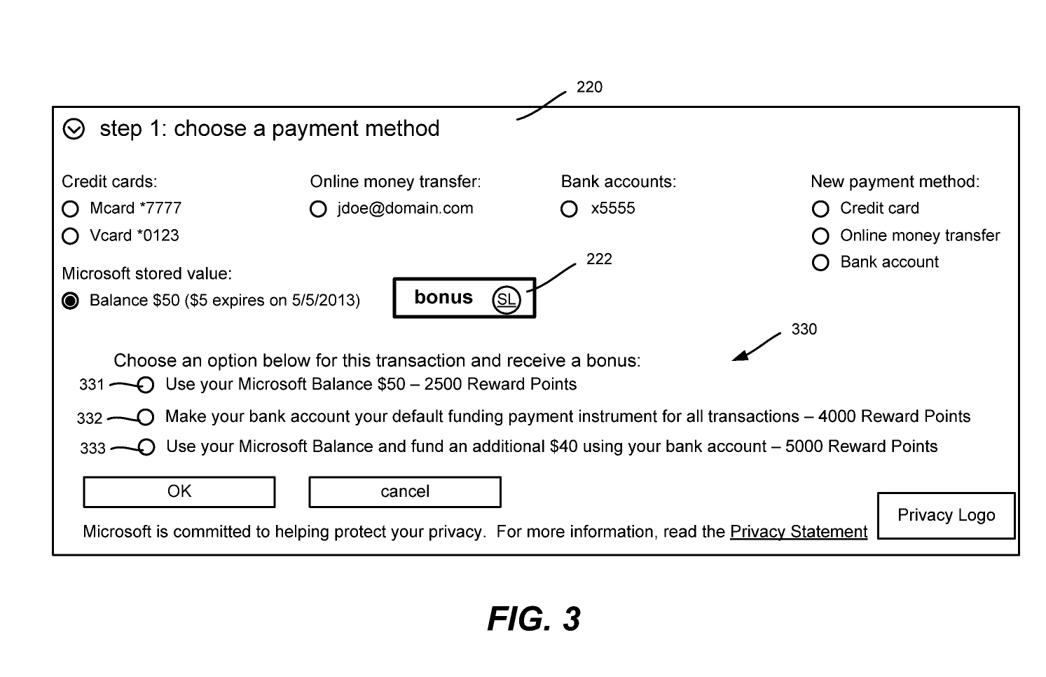

In this example, this customer normally pays with a particular credit card, but is intrigued by the bonus and/or the link to the sponsor. Thus, the user clicks on the bonus button 222, whereby the incentive manager 114 provides options that expand as part of the existing checkout screen, as generally represented in the area 330 of FIG. 3. Note that in one implementation, the incentive manager uses HTML5 and iFrame technology to expand (and when appropriate contract) the screen portion 220 to present a user with multiple options.

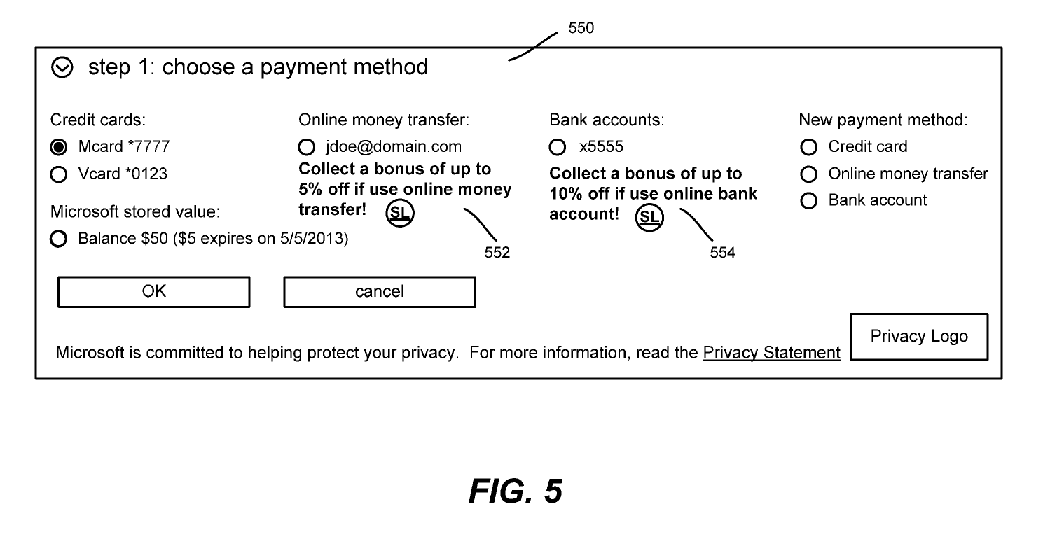

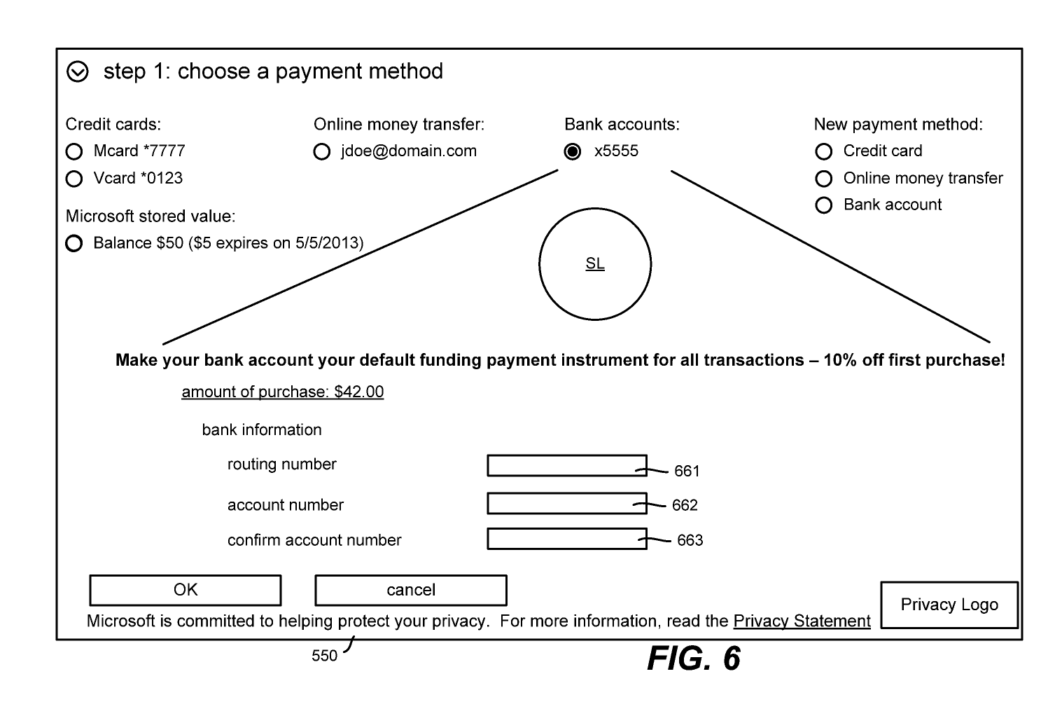

It should be noted that the bonus button is only one suitable mechanism for expanding the incentive manager's expanding screen portion 220 to show the options. Another mechanism is to initially provide the options on the expanded window portion without such a button, as described below with reference to FIGS. 5 and 6. For example, in the above scenario, FIG. 3 (possibly without any bonus button) may be the initial screen presented to the user, which may be visibly enhanced in some way (e.g., via a highly noticeable rectangular border accompanied by the text “bonus”). However, having a bonus button that expands the options has been found to be suitable solution.

Returning to the particular example represented in FIG. 3, via the incentive manager, the user is shown an incentive set comprising three bonus options (there may be a different number in other scenarios, and it Is understood that the three shown herein is only part of the example). Radio buttons 331-333 (a well-known mutually exclusive interaction user interface element/mechanism) allow for user selection/toggling among the options.

A first option (button 331) in this example is to use Currency Stored Value (CSV), in which the incentive offered with this option, based at least in part on the user's historical transaction data and/or the cost savings to the merchant, is 2500 Points; (typically points may be redeemed for rewards such as goods and services). This example scenario is based on the user being a rewards program member; the options are different for a user that is not a rewards program member. For example, if the user was not a rewards program member, the options displayed may include an additional incentive for joining the program, as well as the input fields needed to complete the “Rewards” sign-up process. A cash discount, percentage discount and/or other incentive (e.g., one free music download) may be offered instead of or in addition to the offer to join the rewards program.

As shown in the particular rewards program member example represented in FIG. 3, a second option (button 332) in this example is to make the user's bank (e.g., using ACH, or Automated Clearing House) the default funding payment instrument for this transaction and future transaction. This incentive associated with this option is 4000 Points. A third option (button 333) in this example is to use CSV, fund it with ACH, and purchase an additional $40.00 of CSV. The incentive offered with this option is 5000 Points. The user may also decline the incentives and continue with the checkout without making changes to the default payment instrument.

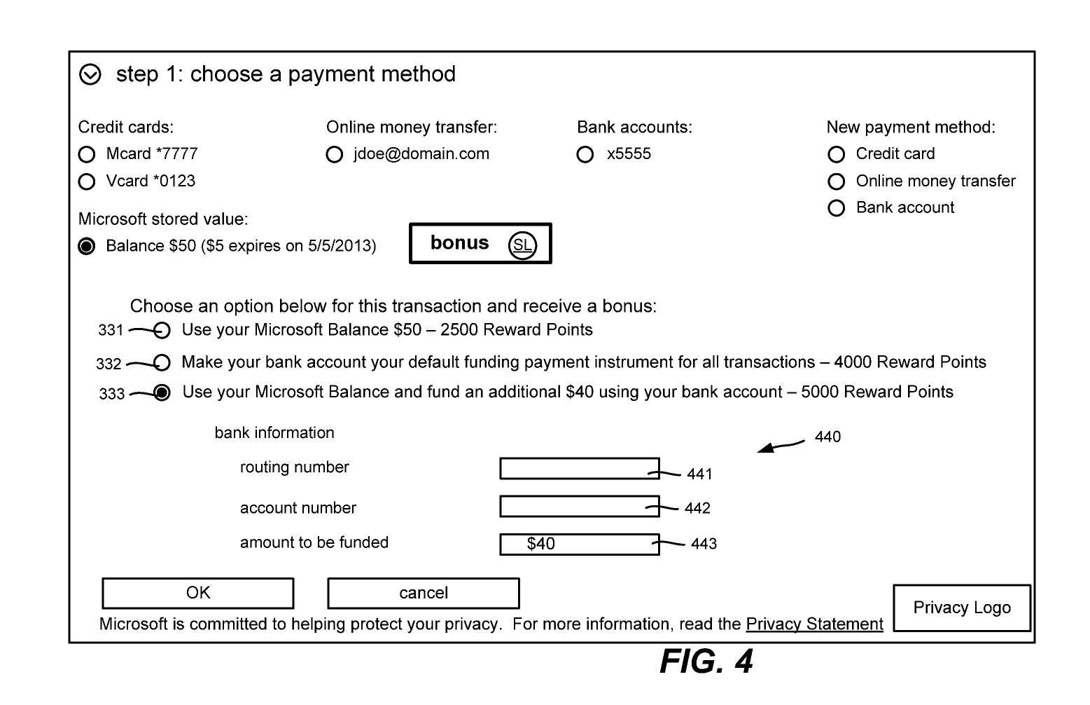

As the user clicks on the radio buttons, the incentive manager 114 expands the screen portion 220 to display the fields for data input, if any, that correspond to the currently selected option. In the example represented in FIG. 4, the user has selected the third option via button 333 to receive the maximum offered bonus of 5000 Points. As a result, additional input data is needed from the user. As shown in FIG. 4, to use this option, the user needs to provide at least a bank account number and bank routing number.

Thus, the incentive manager's screen potion 220 expands into the general area 440 as represented in the example of FIG. 4 to offer appropriate input fields 441-443. In this way, the needed input data are entered as part of the expanding screen 220 that is part of the incentive manager 114. Again, the user does not leave this screen or encounter a redirect, instead using same-screen expansion which is “frictionless” for the user and thus does not lead the user to abandon the purchase. The user may also choose to cancel the expanded option selection.

After entering the data, the appropriate validations are completed on the backend. If validated, the user sees a Currency Stored Value balance of $48 ($50 minus the purchase of $42 plus the additional $40 funded), along with a rewards balance increased by 5000 Points after the purchase is completed. The user may complete the transaction by selecting the “OK” button on the Incentive Manager. If so, the incentive manager screen closes and the user is then brought to the next screen in the checkout process (e.g., to provide a confirmation page, receipt, and so forth).

Note that expansion of the data entry area may be in any direction and the expansion may expand to cover other currently irrelevant data areas (e.g., via a pop-up data entry area balloon, which may be semi-transparent). In general, a goal is to have the user perceive that he or she is still on the same input window/screen. Thus, any other way to obtain data without giving the impression of leaving the screen (e.g., displaying all possible data entry areas but enabling only the relevant area or areas as the user interacts) may be alternatively used.

FIGS. 5 and 6 show an example of an alternative implementation in which the checkout window 550 provides bonus information 552 and 554 proximate the payment method, whereby a bonus button is not necessarily needed. In this example, a percentage discount is offered, however a monetary amount, points, and/or other incentive may be similarly presented. Note that a sponsor's logo may appear in conjunction with each offer, which may be the same logo or a different logo.

FIG. 6 shows an example expansion of the window 550 when the user selects one of the incentivized payment options, which in this example is the bank account. As can be seen, bank information input fields 661-663 are expanded into the window 550, whereby the user need not leave the checkout window to provide the information. Note that the incentive text/graphics/animation (text in this example) may also be changed in appearance, e.g., expanded, as may the appearance of any sponsor's logo.

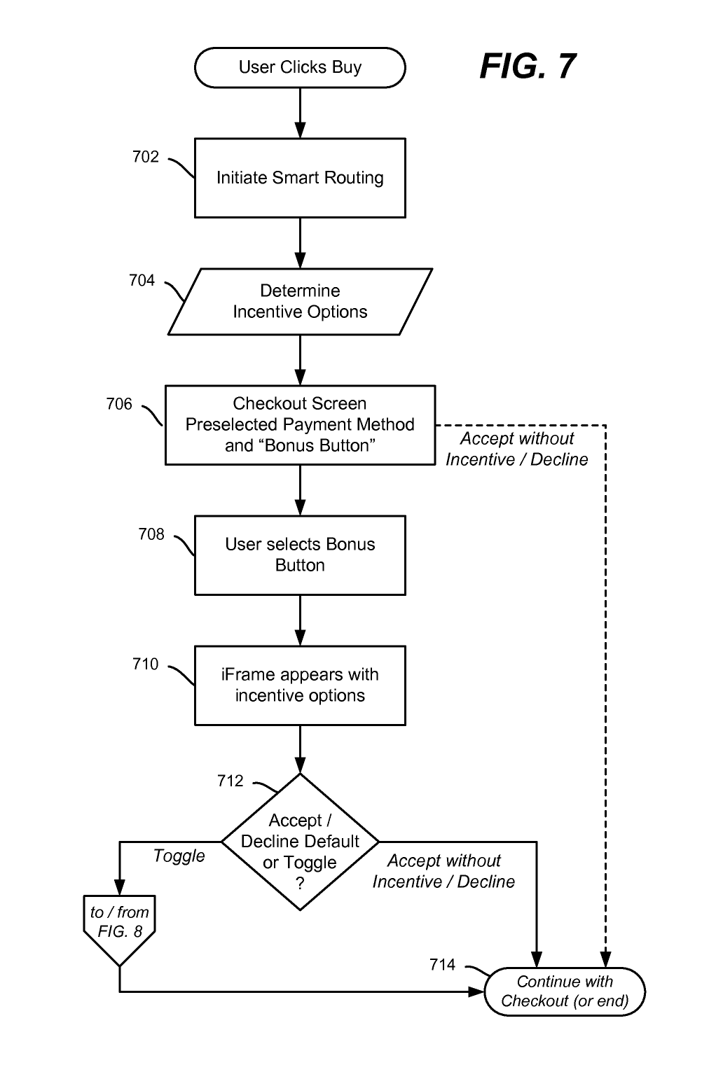

FIG. 7 is a flow diagram summarizing example steps related to offering incentives and to handle user interaction directed towards selecting an incentive, beginning at step 702 where the backend performs “smart routing” (such as generally described in the aforementioned patent application) in order to obtain data corresponding to any incentive-related options to offer. Step 704 represents determining the options, which may be performed at the backend, at the incentive manager, or at a combination of both.

Step 706 presents the checkout screen to the user. Note that the steps of FIG. 7 generally follow some of the actions in the example scenario described above with reference to FIGS. 2-4 and/or FIGS. 5 and 6, e.g., the user is a previous customer with a preselected payment method, there are one or more incentive options to offer (step 704), the user selects the bonus button if one exists (step 708) and so forth. In FIG. 7, the dashed line represents the user instead deciding to accept without an incentive (e.g., by the default or otherwise selected instrument) or decline to make the purchase, by selecting OK or cancel, respectively; note that as part of checkout additional interaction may be needed, e.g., a “submit” confirmation for an “OK” selection, an “Are you sure” prompt for a “cancel” selection, and/or the like; any such additional interaction steps are not shown in FIG. 7.

Step 710 represents expanding the screen portion to show the incentive options, which may be accomplished via an iFrame. At step 712, the user may make a choice, which in this example is to continue with checkout (step 714, accept or decline) or to toggle among the radio buttons. Note that in one alternative, a “cancel” selection at this point may instead collapse the expanded screen and return the user to the previous display.

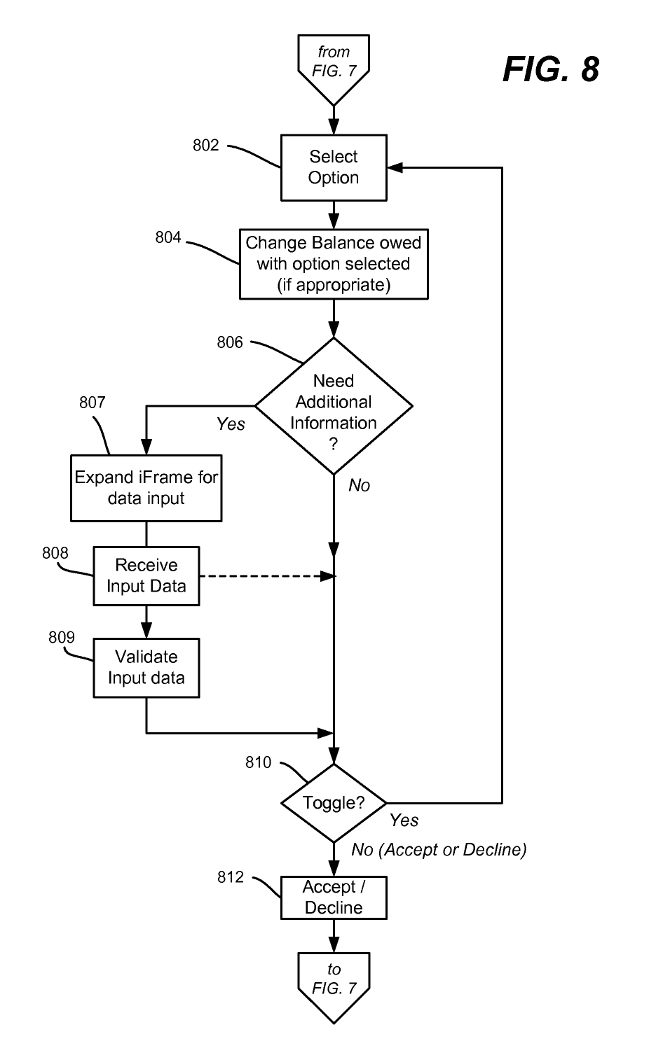

If the user interacts with (toggles) one of the incentive radio buttons, the process continues to FIG. 8, where step 802 represents the user selecting one of the options via the toggle process. Step 804 changes the balance owed, if appropriate, based upon the user selection. For example, the option may correspond to a cash discount, which lowers the price, and such a change is made in a portion of the checkout screen that shows the updated price to reflect such a discount.

Steps 806-809 are directed towards obtaining additional information, such as the bank account data as described above with reference to FIG. 4. If at step 806 additional information is needed, step 807 expands the screen to provide the area/fields for the data input. Step 808 represents receiving the data, which step 809 validates at the backend service; although not explicitly shown, if the validation fails, the user may be prompted to reenter the data. Instead of entering (or reentering) the needed data at step 808, the user may also decide to toggle to another option, or take another action (e.g., cancel), as represented by the dashed line from step 808 to step 810.

If the user decides to toggle to another option, step 810 branches back to step 802. Note that this action overwrites (at step 807) the expanded data fields for additional input with one or more fields that are appropriate for the new selection. If no additional data is needed for an option, the previous fields may be cleared/collapsed, although not explicitly shown in FIG. 8.

The user may ultimately accept or decline, as represented by step 812, which then returns to step 714 of FIG. 7 to complete or end the checkout process. Note that as described above, a cancel selection by a user may instead return the user to a previous state, e.g., prior to one of the expansions, rather than cancel the entire process. Also, a prompt to confirm/obtain additional user input (e.g., “cancel purchase”/“return to default payment”) may be used.

As can be seen, the expanding checkout process enables merchants to manage the calculated cost savings options and gather any needed inputs from customers to implement those options. The technology described herein streamlines the presentation and implementation of incentives into a single screen (whereby the customer does not have to look for deals); further, the user interaction activity may be completed on a single window that is part of the checkout process. Such a single window reduces the user resistance to the checkout process that otherwise may be introduced by making users go to different screens to enter information.

### Example Operating Environment

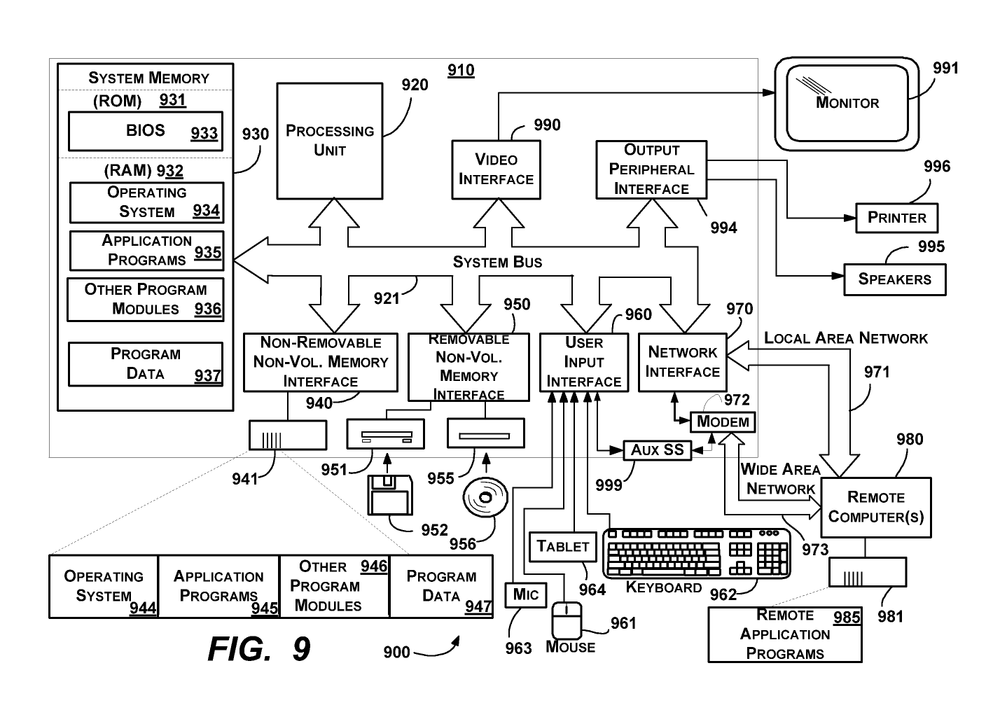

FIG. 9 illustrates an example of a suitable computing and networking environment 900 into which the examples and implementations of any of FIGS. 1-8 as well as any alternatives may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the example operating environment 900.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 9, an example system for implementing various aspects of the invention may include a general purpose computing device in the form of a computer 910. Components of the computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer-readable media. Computer-readable media can be any available media that can be accessed by the computer 910 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 910. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936 and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media, described above and illustrated in FIG. 9, provide storage of computer-readable instructions, data structures, program modules and other data for the computer 910. In FIG. 9, for example, hard disk drive 941 is illustrated as storing operating system 944, application programs 945, other program modules 946 and program data 947. Note that these components can either be the same as or different from operating system 934, application programs 935, other program modules 936, and program data 937. Operating system 944, application programs 945, other program modules 946, and program data 947 are given different numbers herein to illustrate that, at a minimum, they are different copies. A user may enter commands and information into the computer 910 through input devices such as a tablet, or electronic digitizer, 964, a microphone 963, a keyboard 962 and pointing device 961, commonly referred to as mouse, trackball or touch pad. Other input devices not shown in FIG. 9 may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. The monitor 991 may also be integrated with a touch-screen panel or the like. Note that the monitor and/or touch screen panel can be physically coupled to a housing in which the computing device 910 is incorporated, such as in a tablet-type personal computer. In addition, computers such as the computing device 910 may also include other peripheral output devices such as speakers 995 and printer 996, which may be connected through an output peripheral interface 994 or the like.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include one or more local area networks (LAN) 971 and one or more wide area networks (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960 or other appropriate mechanism. A wireless networking component 974 such as comprising an interface and antenna may be coupled through a suitable device such as an access point or peer computer to a WAN or LAN. In a networked environment, program modules depicted relative to the computer 910, or portions thereof, may be stored in the remote memory storage device. By way of example, and not limitation, FIG. 9 illustrates remote application programs 985 as residing on memory device 981. It may be appreciated that the network connections shown are examples and other means of establishing a communications link between the computers may be used.

An auxiliary subsystem 999 (e.g., for auxiliary display of content) may be connected via the user interface 960 to allow data such as program content, system status and event notifications to be provided to the user, even if the main portions of the computer system are in a low power state. The auxiliary subsystem 999 may be connected to the modem 972 and/or network interface 970 to allow communication between these systems while the main processing unit 920 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising, providing an interactive window associated with online commerce, in which the interactive window provides a displayed incentive set comprising one or more displayed options related to use of a corresponding one or more payment instruments, detecting interaction with the displayed incentive set that is directed towards selection of a user-indicated option, and expanding an information input mechanism on the interactive window for collecting information related to the user-indicated option.

2. The method of claim 1 wherein the interactive window provides an interactive mechanism, and wherein providing the incentive set occurs in response to detecting interaction with the interactive mechanism.

3. The method of claim 2 wherein providing the incentive set in response to detecting interaction with the interactive mechanism comprises expanding the displayed incentive set.

4. The method of claim 1 wherein the interactive window provides an interactive mechanism proximate a visible representation of a computed lowest cost payment instrument, and wherein providing the incentive set occurs in response to detecting interaction with the interactive mechanism.

5. The method of claim 1 wherein the information input mechanism comprises one or more data entry fields, and further comprising, collecting the information related to the user-indicated option via the one or more data entry fields.

6. The method of claim 5 further comprising validating the information collected via the one or more data entry fields.

7. The method of claim 5 further comprising, completing an online transaction based upon the information collected via the one or more data entry fields.

8. The method of claim 1 further comprising, communicating with a backend service to obtain data corresponding to the incentive set.

9. The method of claim 1 wherein displayed incentive set comprises a plurality of displayed options, and further comprising detecting further interaction with the displayed incentive set that is directed towards selection of a different user-indicated option, and expanding a different information input mechanism on the interactive window for collecting information related to the different user-indicated option.

10. A system comprising, a memory and a processor which is operatively coupled to the memory and which executes code stored in the memory, the processor, in response to execution of the code, configured to provide an incentive manager, including to provide incentives related to payment instruments for online commerce based upon computed incentive data, in which the incentives are presented to a user on a visible window as an incentive set comprising one or more payment options, at least one payment option associated with an incentive, and if interaction with a payment option is detected and additional information is needed in order to use that payment option, the processor configured to expand an input area on the visible window to provide one or more data entry fields to collect the additional information.

11. The system of claim 10 wherein the processor provides an interactive mechanism on the visible window, the processor configured to expand the incentive set onto the visible window in response to detecting interaction with the interactive mechanism.

12. The system of claim 11 wherein the interactive mechanism comprises a displayed selectable button.

13. The system of claim 10 wherein the interactive mechanism is associated with sponsor-provided information.

14. The system of claim 10 wherein the processor provides the incentives via browser code, executing on the processor, that renders the visible window.

15. The system of claim 10 wherein the processor provides the incentives via browser code, executing on the processor, that renders the visible window.

16. The system of claim 10 wherein data corresponding to the incentive set is obtained from a backend service.

17. The system of claim 10 wherein the incentive set comprises a plurality of payment options, each payment option associated with a radio button user interface element for detection of any interaction with that payment option.

18. One or more computer-readable media having computer-executable instructions, which when executed perform steps, comprising:
providing a checkout window for online commerce, including visible representations of payment instruments for selection;
providing an interactive mechanism directed towards offering incentives;
detecting interaction with the interactive mechanism, and in response, expanding an area of the checkout window to provide an interactive incentive set comprising one or more payment options, at least one of the payment options associated with an incentive; and
detecting interaction with a payment option of the interactive incentive set, and if additional information is needed in order to use that payment option, expanding an area of the checkout window to provide a data entry area to collect the additional information.

19. The one or more computer-readable media of claim 18 wherein additional information is needed in order to use a payment option, and having further computer-executable instructions comprising, collecting the additional information via the data entry area and completing the transaction.

20. The one or more computer-readable media of claim 18 wherein providing the interactive mechanism comprises displaying the interactive mechanism proximate a visible representation of a computed lowest cost payment instrument.
